(19) United States
(12) Patent Application Publication
(10) Pub. No.: US 2026/0054705 A1
(43) Pub. Date: Feb. 26, 2026

(54) WORK VEHICLE WITH SAHR-ACTUATED BRAKE ASSEMBLY AND BRAKING-RELATED SYSTEMS AND METHODS

(71) Applicants: CNH Industrial America LLC, New Holland, PA (US); CNH Industrial Italia S.p.A., Turin (IT)

(72) Inventors: Mark D. Dilts, Mohnton, PA (US); Sudarshan Sirigere, Naperville, IL (US); Corrado Iotti, Turin (IT)

(21) Appl. No.: 18/813,310

(22) Filed: Aug. 23, 2024

(51) Int. Cl. B60T 13/62; B60T 7/04; B60T 7/12; B60T 13/22; B60T 13/68

(52) U.S. Cl. CPC B60T 13/62; B60T 7/04; B60T 7/12; B60T 13/22; B60T 13/686

(57) ABSTRACT

A system for braking a work vehicle includes a brake assembly comprising a primary braking cylinder and a spring-applied, hydraulic-release (SAHR) braking cylinder operatively coupled to the primary braking cylinder. The primary braking cylinder includes a braking piston configured to actuate a brake element to engage and disengage the brake assembly. The system also includes a manual brake input device configured to actuate the braking piston when the work vehicle is operated in a manual mode, and a control valve configured to regulate a supply of pressurized hydraulic fluid to the SAHR braking cylinder. In addition, the system includes a computing system configured to control an operation of the control valve to regulate the supply of pressurized hydraulic fluid to the SAHR braking cylinder such that the SAHR braking cylinder actuates the braking piston when the work

### FIELD OF THE INVENTION

The present disclosure generally relates to work vehicles, such as agricultural vehicles, and, more particularly, to a brake assembly for use within a work vehicle that can be selectively engaged/disengaged via a spring-applied, hydraulic-release (SAHR) braking cylinder as well as braking-related systems and methods.

### BACKGROUND OF THE INVENTION

A work vehicle, such as a tractor or other agricultural vehicle, typically includes two brake input devices, each of which is coupled to a corresponding brake cylinder or service brake for braking an associated wheel of the vehicle. For instance, the work vehicle may include a left brake input device hydraulically connected to a left service brake for braking the left rear wheel of the vehicle and a right brake input device hydraulically connected to a right service brake for braking the right rear wheel of the vehicle. When operated in a manual mode, the operator actuates or presses the brake input devices to engage the service brakes.

In some instances, the vehicle may implement one or more autonomous or driver assistance operations. In such instances, the vehicle's brake assemblies must be actuated with the assistance of a computing system. Accordingly, an improved system and method for braking a work vehicle (particularly in an autonomous or semi-autonomous mode) would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for braking a work vehicle. The system includes a brake assembly comprising a primary braking cylinder and a spring-applied, hydraulic-release (SAHR) braking cylinder operatively coupled to the primary braking cylinder. The primary braking cylinder includes a braking piston configured to actuate a brake element to engage and disengage the brake assembly. The system also includes a manual brake input device configured to actuate the braking piston when the work vehicle is operated in a manual mode, and a control valve configured to regulate a supply of pressurized hydraulic fluid to the SAHR braking cylinder. In addition, the system includes a computing system configured to control an operation of the control valve to regulate the supply of pressurized hydraulic fluid to the SAHR braking cylinder such that the SAHR braking cylinder actuates the braking piston when the work vehicle is operated in an autonomous mode or a semi-autonomous mode.

In another aspect, the present subject matter is directed to a work vehicle including first and second brake assemblies. Each of the first and second brake assemblies includes a primary braking cylinder and a spring-applied, hydraulic-release (SAHR) braking cylinder operatively coupled to the primary braking cylinder. The primary braking cylinder includes a braking piston configured to actuate a brake element to engage and disengage the respective first or second brake assembly. The work vehicle also includes first and second manual brake input devices configured to actuate the braking piston of the first and second brake assemblies, respectively, when the work vehicle is operated in a manual mode, and a control valve configured to regulate a supply of pressurized hydraulic fluid to the SAHR braking cylinder of each of the first and second brake assemblies. In addition, the work vehicle includes a computing system configured to control an operation of the control valve to regulate the supply of pressurized hydraulic fluid to the SAHR braking cylinders of the first and second brake assemblies such that the SAHR braking cylinders actuate the braking pistons of the primary braking cylinders of the first and second brake assemblies when the work vehicle is operated in an autonomous mode or a semi-autonomous mode.

In a further aspect, the present subject matter is directed to method for braking a work vehicle. The work vehicle includes a brake assembly including a primary braking cylinder and a spring-applied, hydraulic-release (SAHR) braking cylinder operatively coupled to the primary braking cylinder, with the primary braking cylinder including a braking piston configured to actuate a brake element to engage and disengage the brake assembly. The method includes receiving, with a computing system, an input associated with switching an operation of the work vehicle from a manual mode to an autonomous or semi-autonomous mode, and controlling, with the computing system, an operation of a control valve to regulate a supply of pressurized hydraulic fluid to the SAHR braking cylinder such that the SAHR braking cylinder actuates the braking piston to engage and disengage the brake assembly.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of one embodiment of a work vehicle in accordance with aspects of the present subject matter;

FIG. 2 illustrates a schematic, top view of the work vehicle shown in FIG. 1 in accordance with aspects of the present subject matter;

FIG. 3 illustrates a cross-sectional view of one embodiment of a brake assembly in accordance with aspects of the present subject matter;

FIG. 4 illustrates another schematic, top view of the work vehicle shown in FIG. 1, particularly illustrating one embodiment various control-related components/systems of the work vehicle in accordance with aspects of the present subject matter;

FIG. 5 illustrates a schematic view of one embodiment of a brake control system of a work vehicle in accordance with aspects of the present subject matter; and

FIG. 6 illustrates a flow diagram of one embodiment of a method for braking a work vehicle in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to SAHR-actuated brake assemblies for work vehicles and related systems and methods for braking work vehicles. Specifically, in several embodiments, the disclosed brake assembly includes a primary braking cylinder and a spring-applied, hydraulic-release (SAHR) braking cylinder operatively coupled to the primary braking cylinder. During operation in a manual mode of the work vehicle, the primary braking cylinder may be actuated by the operator via a manual brake input device (e.g., a brake pedal) to engage or actuate the brakes. Additionally, during operation in an autonomous or semi-autonomous mode of the work vehicle, a computing system may be configured to control the operation of an associated control valve to regulate the actuation of the SAHR braking cylinder, which, in turn, is coupled to a braking piston of the primary braking cylinder such that actuation of the SAHR braking cylinder can be used to engage or disengage the brakes.

As used throughout this disclosure, the term “autonomous” refers to a vehicle or operating mode capable of implementing at least one operation without driver input. An “operation” refers to a change in one or more of the steering, braking, acceleration/deceleration of the vehicle, actuation of a component of an implement, actuation of a component of a trailer, and/or actuation of any other component of the vehicle and/or any assembly operably coupled with the vehicle. The term “semi-autonomous” refers to a vehicle capable of implementing at least one operation that is not fully automatic but assists the operator with such operation (e.g., fully operational without a driver or without driver input). As such, an autonomous vehicle includes those that can operate under operator control during certain time periods and without operator control during other time periods while a semi-autonomous vehicle includes those that can operate under operator control during certain time periods and assist with operator control during other time periods.

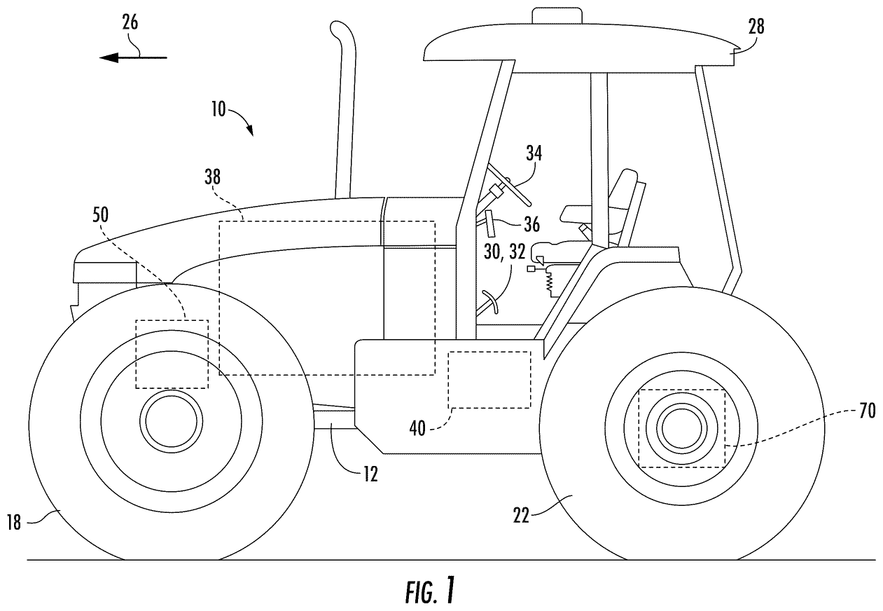

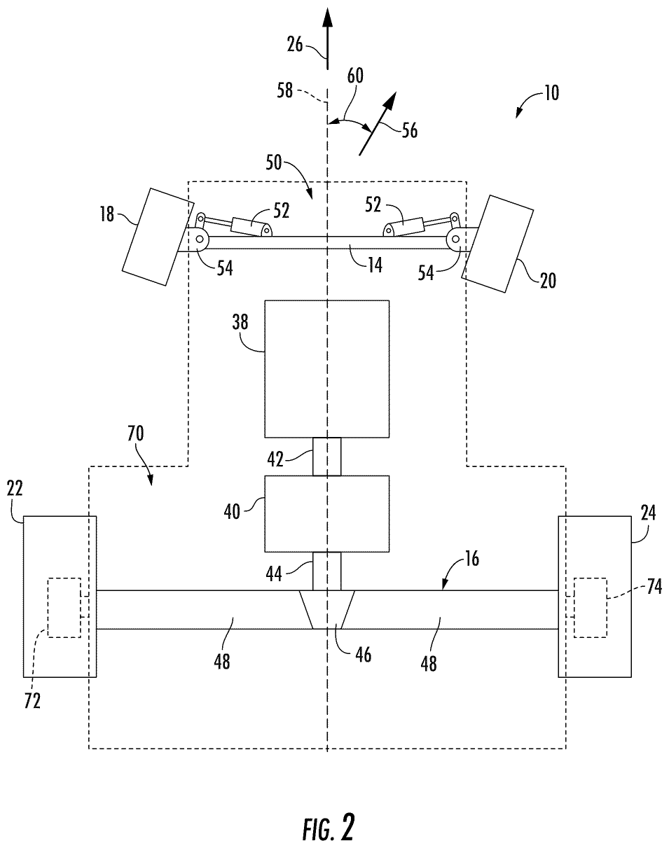

Referring now to the drawings, FIGS. 1 and 2 illustrate differing views of one embodiment of a work vehicle 10 in accordance with aspects of the present subject matter. Specifically, FIG. 1 illustrates a side view of the work vehicle 10, and FIG. 2 illustrates a schematic, top view of the work vehicle 10, particularly illustrating various components of the vehicle 10. As shown, the work vehicle 10 is configured as an agricultural tractor. However, in other embodiments, the work vehicle 10 may be configured as any other suitable work vehicle known in the art, including those for agricultural and construction applications, transport, sport, and/or the like.

The work vehicle 10 may include a frame or chassis 12 (FIG. 1) configured to support or couple to a plurality of components. As shown in FIG. 2, front and rear axles 14, 16 may be supported relative to the chassis 12, with each axle 14, 16 having a pair of traction devices coupled thereto for engaging the ground. In the illustrated embodiment, the traction devices correspond to wheels, namely a pair of steerable front wheels 18, 20 and a pair of driven rear wheels 22, 24. In an alternative embodiment, the front wheels 18, 20 may be driven in addition to the rear wheels 22, 24. Regardless, the wheels 18, 20, 22, 24 may be configured to support the work vehicle 10 relative to the ground to allow the vehicle 10 to be moved in a direction of travel (e.g., as indicated by arrow 26 in FIGS. 1 and 2) across a field.

It should be appreciated that, as used herein, the term “wheel” is used broadly and is intended to cover various embodiments of rolling support devices, including a wheel with or without a tire provided in associated therewith. For example, in several embodiments, the term “wheel” may correspond to a wheel configured to directly contact or engage the driving surface around its outer perimeter or the term “wheel” may correspond to a wheel configured to contact or engage the driving surface via a tire or suitable inflatable member installed around its outer perimeter. It should also be appreciated that, in other embodiments, the traction devices may correspond to track assemblies or any other suitable traction devices.

Additionally, an operator's cab 28 (FIG. 1) may be supported by a portion of the chassis 12 and may house various control or input devices 30, 32, 34 (e.g., levers, pedals, control panels, buttons and/or the like) for permitting an operator to control the operation of the work vehicle 10. For instance, as shown in FIG. 1, the work vehicle 10 may include one or more actuatable pedals, such as one or more brake pedals (e.g., left and right brake pedals 30, 32) for manually actuating the vehicle's brakes, and a steering wheel 34 for permitting an operator to manually steer the work vehicle 10. In addition, the work vehicle 10 may include a control panel or user interface 36 (FIG. 1) within the cab 28 for displaying message windows and/or alerts to the operator and/or for allowing the operator to interface with the vehicle's controller. For instance, in one embodiment, the user interface 36 may include buttons, knobs and/or any other suitable input devices that allow the operator to provide user inputs to the controller, such as by allowing the operator to provide an input instructing the controller to operate the work vehicle 10 in an autonomous or semi-autonomous mode.

Moreover, as shown, the work vehicle 10 may include an engine 38 and a transmission 40 configured to be mounted on the chassis 12 of the work vehicle 10. The transmission 40 may be operably coupled to the engine 38 via one or more shafts 42 (FIG. 2) and may be configured to provide variably adjusted gear ratios for transferring engine power to the driven wheels 22, 24 via the rear axle 16. For example, as shown in FIG. 2, an output shaft 44 of the transmission 40 may be coupled to a differential 46, which, in turn, is coupled to one or more axle shafts 48 forming the rear axle 18 for transferring power to the driven wheels 22, 24. It should be appreciated that, in other embodiments, the work vehicle 10 may have any other prime mover configuration or system, including by being configured as a battery-powered or electric vehicle using electric motor propulsion.

Referring still to FIGS. 1 and 2, in several embodiments, the work vehicle 10 may also include a steering assembly 50 for adjusting the direction of travel 26 of the work vehicle 10. As shown in FIG. 2, the steering assembly 50 may include one or more steering actuators 52 coupled to the steerable wheels 20, 22 (e.g., via steering knuckles 54). As a result, extension and/or retraction of the steering actuators 52 results in the orientation or steering direction 56 (FIG. 2) of the steerable wheels 20, 22 being adjusted relative to the chassis 12, thereby varying the direction of travel 26 of the vehicle 10. Specifically, the steering actuators 52 may be configured to pivot or otherwise rotate the steerable wheels 20, 22 relative to the chassis 12 about the steering knuckles 54 based on a received input (e.g., from the steering wheel 32 or control signals from the controller, such as when operating within an autonomous or semi-autonomous mode) in a manner that aligns the steering direction 56 of the wheels 20, 22 with the intended direction of travel of the vehicle 10. It should be appreciated that, as described herein, each steering actuator 52 is configured as a hydraulic actuator or cylinder. However, in other embodiments, each steering actuator 52 may correspond to an electric motor, a linear actuator, a pneumatic cylinder, or any other suitable actuator coupled to a suitable mechanical linkage or assembly, such as a rack and pinion or a worm gear assembly, for steering the steerable wheels 20, 22.

As an example, FIG. 2 illustrates the steerable wheels 20, 22 after such wheels have been pivoted to the right relative to a longitudinal axis (e.g., as indicated by dashed line 58 in FIG. 2) of the chassis 12. In such instance, the direction of travel 26 of the work vehicle 10 may similarly be oriented to the right, thereby causing the vehicle 10 to turn right. Furthermore, when the work vehicle 10 is being turned, a steering angle (e.g., as indicated by arrow 60 in FIG. 2) may be defined between the steering direction 56 of the wheels 20, 22 and the longitudinal axis 58 of the chassis 12.

Moreover, the work vehicle 10 may include a braking system 70 for applying a braking force or braking action for slowing the vehicle 10. In several embodiments, the braking system 70 may include one or more brake assemblies 72, 74 provided in operative association with one or more respective wheels and/or one or more respective axle shafts 48 of the rear axle 16 to apply a braking force thereto. For example, as shown in FIG. 2, first and second or left and right brake assemblies 72, 74 are provided in operative association with the left and right driven wheels 22, 24, respectively (or the respective axle shafts 48 associated with such wheels 22, 24). In this regard, the first brake assembly 72, when activated, may be configured to reduce the wheel speed of or otherwise slow the rotation of the associated wheel 22. Similarly, the second brake assembly 74, when activated, may be configured to reduce the wheel speed of or otherwise slow the rotation of the associated wheel 24. In this regard, the brake assemblies 72, 74 may be configured for independent activation, thereby allowing for independent braking when executing tight turns or other steering maneuvers.

It should be appreciated that the configuration of the work vehicle 10 described above and shown in FIGS. 1 and 2 is provided only to place the present subject matter in an exemplary field of use. Thus, it should be appreciated that the present subject matter may be readily adaptable to any manner of work vehicle configuration. For example, in an alternative embodiment, the work vehicle 10 may include an articulated chassis to steer the work vehicle 10. Additionally, the work vehicle 10 may also be configured to be operably coupled to any suitable type of work implement, including any drawn implement or any implement configured to be coupled to the vehicle 10 via a three-point hitch.

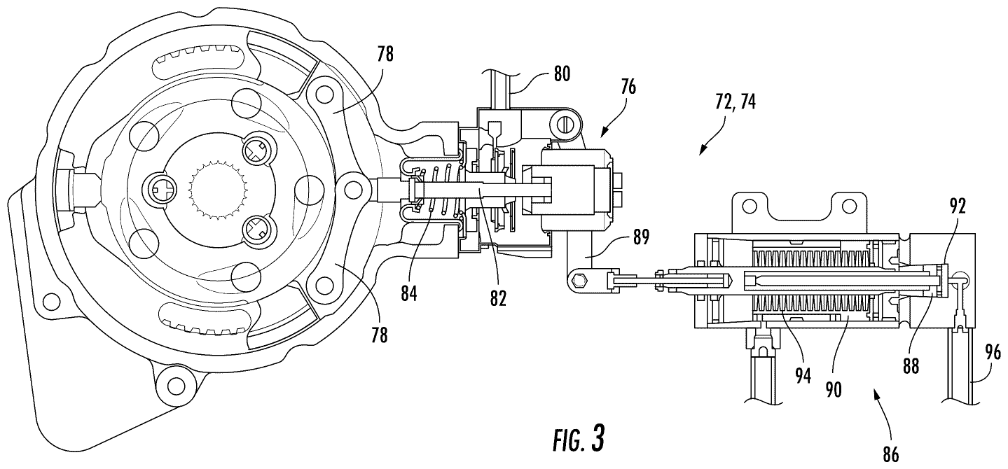

Referring now to FIG. 3, a simplified, cross-sectional of one embodiment of one of the brake assemblies 72, 74 described above is illustrated in accordance with aspects of the present subject matter. In general, each brake assembly 72, 74 may have a hybrid service/SAHR braking configuration. Specifically, in several embodiments, each brake assembly 72, 74 may include a primary braking cylinder 76 (e.g., a hydraulic braking cylinder) configured to actuate one or more brake elements 78, such as a brake linkage, a brake shoe or brake calipers, against rotating elements (not shown), such as brake drums or brake discs. This primary braking cylinder 76 may, for example, correspond to the service braking cylinder conventionally used for the service brakes of a work vehicle and, as such, may be configured to be hydraulically actuated in response to an input provide by the operator. For instance, as shown in FIG. 3, the primary braking cylinder 76 may be configured to be actuated via hydraulic fluid supplied via a primary or “service” brake line 80. The flow of hydraulic fluid through the service brake line 80 may, in turn, be controlled by the operator via manipulation of corresponding manual brake input devices provided in the cab 28, such as the first and second brake pedals 30, 32. As such, when the operator presses down on the brake pedals 30, 32, a braking piston 82 (and associated piston rod) of the primary braking cylinder 76 of each brake assembly 72, 74 may be actuated against the brake elements 78 in a manner that engages each brake assembly 72, 74, thereby slowing the rotational speed of the associated wheel 22, 24. Similarly, when the operator releases the brake pedals 30, 32, the brake assemblies 72, 74 may be disengaged. As shown in FIG. 3, the primary braking cylinder 76 may include a spring 84 that biases the braking piston 82 into a disengaged position at which each brake assembly 72, 74 is disengaged.

In addition, each brake assembly 72, 74 may include a SAHR braking cylinder 86 provided in operative association with the primary braking cylinder 76. In several embodiments, the SAHR braking cylinder 86 may be mechanically coupled to the braking piston 82 of the primary braking cylinder 76 via a linkage 89 (e.g., a lever or any other suitable mechanical connection or linkage) to allow the brake assembly 72, 74 to be activated independent of the brake pedals 30, 32 or other operator inputs. For instance, in one embodiment, the SAHR braking cylinder 86 may be mechanically coupled to the braking piston 82 of the primary braking cylinder 76 via the same lever or linkage that is typically utilized to couple an associated Bowden cable or similar linkage of the vehicle's parking brake system to allow the piston 82 to be actuated when applying the parking brake. As will be described below, the incorporation of the SAHR braking cylinder 86 to each brake assembly 72, 74 may allow the brake assemblies 72, 74 to be controlled automatically when the work vehicle 10 is operating in an autonomous or semi-autonomous mode to function as service brakes for the work vehicle 10. In addition, the SAHR braking cylinders 86 may also allow for the application of the parking brake (e.g., as a replacement of the Bowden cable) or emergency brake of the work vehicle 10.

As shown in FIG. 3, the SAHR braking cylinder 86 may include a SAHR piston 88 (and associated piston rod) and opposed cylinder chambers (e.g., a spring chamber 90 and a fluid chamber 92), with a spring 94 being included within the spring chamber 90 for biasing the SAHR piston 88 (and also the braking piston 82 coupled thereto) in a first direction (e.g., a brake engagement direction). The opposed fluid chamber 92 is fluidly coupled to a SAHR brake line 96 for allowing hydraulic fluid to be supplied to the chamber 92 to actuate the SAHR piston 88 (and also the braking piston 82 coupled thereto) in an opposed second direction (e.g., in a brake disengagement direction). In such an embodiment, the SAHR braking cylinder 86 may be mechanically coupled to the braking piston 82 of the primary braking cylinder 76 (e.g., via the linkage 89) such that the SAHR-based spring 94 is configured to bias the brake assembly 72, 74 into its engaged state. As a result, to release or disengage the brake assembly 72, 74, pressurized fluid must be supplied to the fluid chamber 92 to actuate the SAHR piston 88 against the bias of the spring 84, thereby causing the braking piston 82 of the primary braking cylinder 76 to be correspondingly actuated to its disengaged state or position.

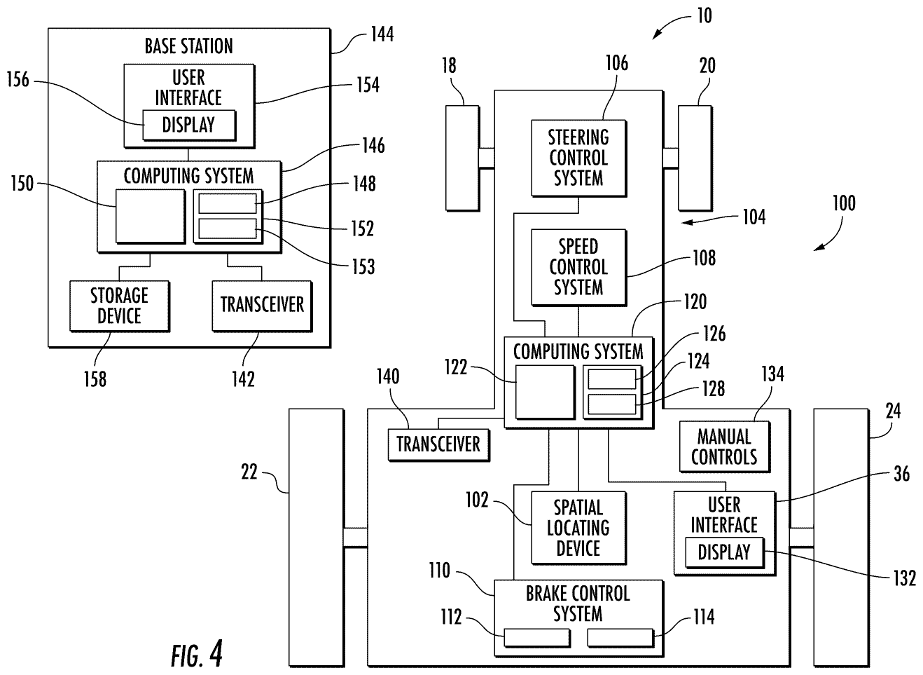

Referring now to FIG. 4, another schematic, top view of the work vehicle 10 is illustrated in accordance with aspects of the present subject matter, particularly illustrating various control-related components of the vehicle 10. As shown, the work vehicle 10 may include a control system 100 configured to assist, perform, or otherwise facilitate operations (e.g., vehicle movement operations, implement-related operations, etc.). For example, the control system 100 may automatically guide the work vehicle 10 to perform certain operations.

In several embodiments, the control system 100 includes a spatial locating device 102, which can be mounted to the work vehicle 10 and configured to determine a position and, in certain cases, a velocity of the work vehicle 10. The spatial locating device 102 may include any suitable system configured to measure and/or determine the position of the work vehicle 10, such as a GPS receiver, for example.

In the illustrated example, the control system 100 can include a movement control system 104. In various examples, the movement control system 104 can include a steering control system 106 configured to control a direction of movement of the work vehicle 10, a speed control system 108 (which can include the engine 38 and the transmission 40 or any other suitable primer mover-related components, including electric propulsion motors for an electric vehicle) configured to control a speed of the work vehicle 10, and/or a brake control system 110. In some cases, the brake control system 110 may be able to detect when the vehicle is operated in a manually operated mode or an autonomous or semi-autonomous mode. In such instances, the brake control system 110 may utilize a manual brake module 112 when operated in a manually operated mode and an autonomous module 114 when operated in an autonomous or semi-autonomous mode.

In addition, the control system 100 includes a computing system 120, which can be communicatively coupled to the spatial locating device 102, the steering control system 106, the speed control system 108, and/or the brake control system 110. In some cases, the computing system 120 can be configured to automatically control the work vehicle 10 during certain phases of agricultural operations (e.g., without operator input, with limited operator input, etc.). In general, the computing system 120 may include any suitable processor-based device, such as a computing device or any suitable combination of computing devices. Thus, in several examples, the computing system 120 may include one or more processors 122 and associated memory device 124 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. The memory device 124 may store processor-executable instructions (e.g., firmware or software) for the processor 122 to execute, such as instructions for controlling the work vehicle 10, instructions for determining a plan for the work vehicle 10, and so forth. In certain embodiments, the memory device 124 may include one or more tangible, non-transitory, computer-readable media (e.g., machine-readable media) that store instructions 126 executable by the processor 122 (e.g., configured to cause the processor 122 to perform certain operations) and/or data 128 to be processed by the processor 122. The storage device(s) (e.g., nonvolatile storage) may include ROM, flash memory, a hard drive, or any other suitable optical, magnetic, or solid-state storage medium, or a combination thereof. The storage device(s) may store data 128 (e.g., position data, vehicle geometry data, etc.), instructions (e.g., software or firmware for controlling the work vehicle 10, etc.), and any other suitable data. In addition, the computing system 120 may also include various other suitable components, such as a communications circuit or module, one or more input/output channels, a data/control bus, and/or the like.

It will be appreciated that, in several examples, the computing system 120 may correspond to an existing controller of the vehicle 10, or the computing system 120 may correspond to one or more separate processing devices. For instance, in some examples, the computing system 120 may form all or part of a separate plug-in module or computing device(s) that is installed relative to the vehicle 10 to allow for the disclosed systems and methods to be implemented without requiring additional software to be uploaded onto existing control devices of the vehicle 10.

In various examples, the steering control system 106 may include a wheel angle control system, a torque vectoring system, or a combination thereof. The wheel angle control system may automatically pivot one or more wheels 18, 20 of the work vehicle 10 (e.g., via actuators 52) to steer the work vehicle 10 along a target route through a work area. In addition, the torque vectoring system may differentially apply torque from the engine 38 (or other prime mover) to the driven wheels 22, 24 on each lateral side of the work vehicle 10, thereby directing the work vehicle 10 along a path. In further examples, the steering control system 106 may include other and/or additional systems to facilitate directing the work vehicle 10 along a path through the work area.

In various examples, the speed control system 108 may include an prime mover output control system, a transmission control system, or a combination thereof. The prime mover output control system may vary the output of the engine 38 (or other prime mover) to control the speed of the work vehicle 10. For example, the prime mover output control system may vary a throttle setting of the engine 38, a fuel/air mixture of the engine 38, a timing of the engine 38, and other suitable engine parameters to control the engine output or a combination thereof. In addition, the transmission control system may adjust a gear ratio of the transmission 40 (e.g., by adjusting gear selection in a transmission 40 with discrete gears, by controlling a continuously variable transmission (CVT), etc.) to control the speed of the work vehicle 10. In further examples, the speed control system 108 may include other and/or additional systems to facilitate adjusting the speed of the work vehicle 10.

In various examples, the brake control system 110 may adjust the braking force applied to the wheels/axles, thereby controlling the speed of the work vehicle 10. In various examples, the brake control system 110 may be configured to control each of the brake assemblies 72, 74 of the vehicle 10. As provided herein, the brake control system 110 may be able to detect when the vehicle 10 is operated in a manually operated mode or an autonomous or semi-autonomous mode. In such instances, the brake control system 110 may utilize a manual brake module when operated in a manually operated mode and an autonomous module when operated in an autonomous or semi-autonomous mode for controlling the brake assemblies 72, 74 of the work vehicle 10. For instance, when the vehicle 10 is operated in a manual mode, an input may be provided to the primary braking cylinder(s) 76 from an associated brake pedal 30, 32, which in turn, operates the associated brake assembly(ies) 72, 74 of the vehicle 10. When the vehicle 10 is operated in an autonomous or semi-autonomous mode in which one or more of the brake assemblies 72, 74 are actuated without direct operator input, a control valve (and/or a related control valve assembly) may provide an input to the SAHR braking cylinder(s) 86, which in turn, operates the associated brake assembly(ies) 72, 74 of the vehicle 10.

It should be appreciated that the work vehicle 10 may be configured to operated in the autonomous or semi-autonomous mode using any suitable inputs, including inputs from various sensors or other devices onboard the vehicle 10. For instance, the work vehicle 10 may be equipped with perception sensors (e.g., cameras, LIDAR devices, radar sensors, etc.) for perceiving its environment (e.g., for automatic guidance, obstacle detections, etc.). In addition, the work vehicle 10 may use position data (e.g., GPS data) from the spatial locating device 102 to allow for automatic guidance. In accordance with aspects of the present subject matter, this input data may also be used in automatically controlling the components of the brake control system 110 when executing braking operations (e.g., braking the vehicle upon detection of an obstacle via the perception sensors or braking the vehicle upon making a headland turn based on GPS or other position data).

In the illustrated example, the control system 100 includes a user interface 36 (e.g., including a graphical user interface, a GUI) communicatively coupled to the computing system 120. The user interface 36 is configured to enable an operator to control certain parameter(s) associated with the operation of the work vehicle 10. For example, the user interface 36 may include a switch that enables the operator to selectively configure the work vehicle 10 for autonomous or manual operation. In addition, the user interface 36 may include a battery cut-off switch, an engine ignition switch, a stop button, or a combination thereof, among other controls. In various examples, the user interface 26 includes a display 132 configured to present information to the operator, such as a map of the work area, a visual representation of certain parameter(s) associated with the operation of the work vehicle 10 (e.g., fuel level, oil pressure, water temperature, etc.), or a combination thereof, among other information. In various examples, the display 132 may include a touchscreen interface that enables the operator to control certain parameters associated with the operation of the work vehicle 10. For example, the user interface 36, via the display 132, may enable the operator to identify actions to be performed and action locations for the identified actions in the work area, and/or the user interface 36, via the display 132, may enable the operator to view transition operations associated with the actions, as determined by the control system 100.

In the illustrated example, the control system 100 can also include manual controls 134 (e.g., including brake pedals 30, 32 and steering wheel 34 shown in FIG. 1) configured to enable an operator to control the work vehicle 10 while automatic control is disengaged. The manual control 134 may include manual steering control, manual transmission control, manual braking control, or a combination thereof, among other controls. In the illustrated example, the manual controls 134 are communicatively coupled to the computing system 120. The computing system 120 is configured to disengage automatic control of the work vehicle 10 upon receiving a signal indicative of manual control of the work vehicle 10. Accordingly, if an operator controls the work vehicle 10 manually, the automatic control terminates, thereby enabling the operator to control the work vehicle 10.

With further reference to FIG. 2, the control system 100 can include a transceiver 140 communicatively coupled to the computing system 120. The transceiver 140 is configured to establish a communication link with a corresponding transceiver 142 of a base station 144, thereby facilitating communication between the base station 144 and the control system 100 of the work vehicle 10. The transceiver 140 may operate at any suitable frequency range within the electromagnetic spectrum. In addition, the transceiver 140 may utilize any suitable communication protocol, such as a standard protocol (e.g., Wi-Fi, Bluetooth, etc.) or a proprietary protocol. In various examples, the base station 144 may be a handheld device, a laptop, or another suitable device.

In several examples, the base station 144 includes a computing system 146 communicatively coupled to the base station transceiver 142. The computing system 146 is configured to output commands and/or data 148 to the computing system 120 of the work vehicle 10. For example, the computing system 146 may be configured to determine a plan and to output one or more signals indicative of the plan to the work vehicle computing system 120, thereby enabling the work vehicle computing system 120 to instruct the movement control system 104 to direct the work vehicle 10 along a route of the plan.

In various examples, the computing system 146 is an electronic controller having electrical circuitry configured to process data 148 from certain components of the base station 144 (e.g., the transceiver 142). In the illustrated embodiment, the computing system 146 includes a processor, such as the illustrated processor 150, and a memory device 152. The processor 150 may be used to execute software, such as software for determining a plan, and so forth. Moreover, the processor 150 may include multiple microprocessors, one or more “general-purpose” microprocessors, one or more special-purpose microprocessors, and/or one or more application-specific integrated circuits (ASICS), or some combination thereof. For example, the processor 150 may include one or more reduced instruction set (RISC) processors. The memory device 152 may include a volatile memory, such as RAM, and/or a nonvolatile memory, such as ROM. The memory device 152 may store a variety of data 148 and may be used for various purposes. For example, the memory device 152 may store processor-executable instructions 153 (e.g., firmware or software) for the processor 150 to execute, such as instructions for determining a plan.

In the illustrated example, the base station 144 includes a user interface 154 communicatively coupled to the computing system 146. The user interface 154 is configured to present data from the work vehicle 10 to an operator (e.g., data associated with the operation of the work vehicle 10, etc.). The user interface 154 is also configured to enable an operator to control certain functions of the work vehicle 10 (e.g., starting and stopping the work vehicle 10, instructing the work vehicle 10 to follow a route through the work area, identifying actions of the work vehicle 10 and corresponding action locations, etc.). In the illustrated embodiment, the user interface 154 includes a display 156 configured to present information to the operator, such as information about the work area, actions of the work vehicle 10, transition operations associated with actions, the position of the work vehicle 10 within the work area, the speed of the work vehicle 10, and the path of the work vehicle 10, among other data.

In the illustrated embodiment, the base station 144 includes a storage device 158 communicatively coupled to the computing system 146. The storage device 158 (e.g., nonvolatile storage) may include ROM, flash memory, a hard drive, or any other suitable optical, magnetic, or solid-state storage medium, or a combination thereof. The storage device(s) may store data, instructions (e.g., software or firmware for determining a plan, etc.), and any other suitable data. In some examples, the control system 100 may include the base station 144 or portion(s) thereof, such as the transceiver 142, the computing system 146, the user interface 154, and/or the storage device 158. In various examples, the control system 100 may include other and/or additional controllers/control systems.

In various examples, the computing system 120 is configured to determine a plan for the work vehicle 10, including actions to be performed by the work vehicle 10 within the work area (e.g., a field), locations of the actions (e.g., action locations), and transition operations associated with the actions that enable the work vehicle 10 to perform the actions at the action locations. For example, prior to the operation of the work vehicle 10, the computing system 120 may determine a transition operation for each action that may facilitate the performance of the action at a respective action location. The transition operation may include a transition action that is performed by the work vehicle 10 before the action and a transition location of the transition action. The transition operation (e.g., the transition action and the transition location) may depend on the associated action, the action location, a speed of the work vehicle 10 (e.g., initial speed, expected speed, etc.), a terrain of the work area, a type of the work vehicle 10, a type of the implement, an expected weight of the work vehicle 10 along the path of the work vehicle 10 (e.g., at the transition location, at the action location, and/or elsewhere), expected weather conditions during operation of the work vehicle, one or more user inputs, or a combination thereof. The computing system 120 may generate the plan for operating the work vehicle 10, including a path through the work area and the actions and transition operations performed along the path. In some examples, the computing system 120 may generate and/or modify the path based on the transition operations, the actions, the action locations, or a combination thereof. In various examples, the control system 100 may display the plan via the user interface 36 to enable a user to view, approve, and/or modify the plan. For example, the user may approve and/or modify the plan as a whole, each transition operation, or portion(s) of each transition operation.

In various examples, the work vehicle computing system 120 determines the plan and outputs instructions to execute the plan (e.g., outputs instructions to the movement control system 102 to direct the work vehicle 10 along the path). However, in further examples, the plan may be determined and/or instructions to execute the plan may be output by one or more other controllers (e.g., alone or in combination with the work vehicle computing system 120). For example, in various examples, the control system 100 includes the base station computing system 146. In such examples, the base station computing system 146 may determine the plan and output one or more signals indicative of the plan to the work vehicle computing system 120 (e.g., via the respective transceivers). The work vehicle computing system 120 may then output one or more signals indicative of instructions to execute the plan (e.g., instructions to the movement control system 102 to direct the work vehicle 10 along a path of the plan). In further examples, the base station computing system 146 may determine the plan and output one or more signals to the movement control system 102 and/or other components of the system (e.g., via the respective transceivers, via the work vehicle controller, etc.) indicative of instructions to execute the plan (e.g., instructions to direct the work vehicle along a path of the plan, etc.). In examples in which the control system 100 includes the base station computing system 146, the base station computing system 146 may determine the plan for multiple work vehicles and output one or more signals indicative of the plan (e.g., including respective paths of the plan) or instructions to execute the plan to each work vehicle 10 (e.g., to the controller of each work vehicle 10, to the movement control system 102 of each work vehicle 10, etc.).

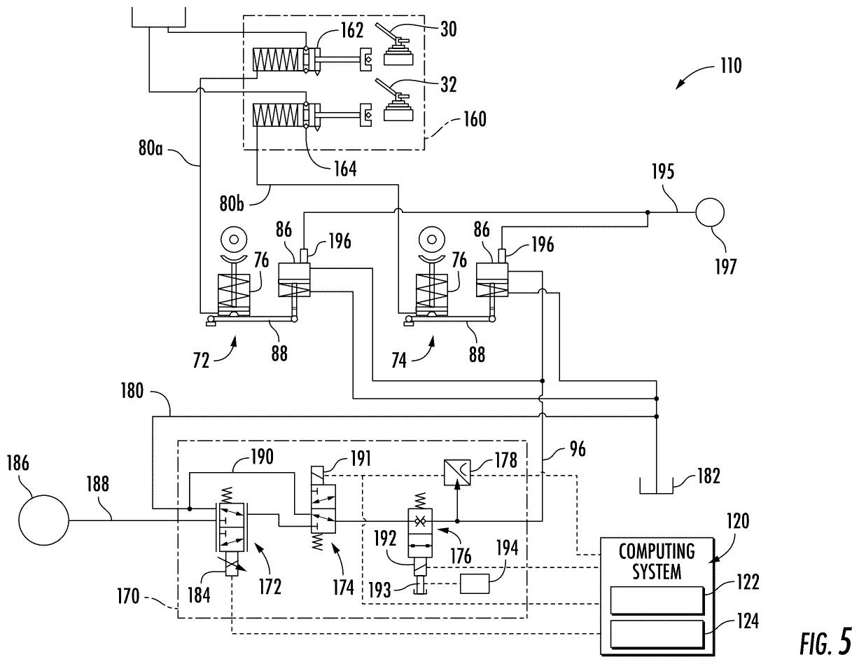

Referring now to FIG. 5, a schematic view of one embodiment of a brake control system 110 for controlling one or more brake assemblies of a work vehicle 10 is illustrated in accordance with aspects of the present subject matter. In general, the brake control system 110 will be described herein with reference to the work vehicle 10 described above with reference to FIGS. 1 and 2, the brake assemblies 72, 74 described above with reference to FIG. 3, and the control system 100 described above with reference to FIG. 4. However, it should be appreciated that, in general, the brake control system 110 may be utilized with any suitable work vehicle, any suitable brake assembly, and/or any suitable control system.

As shown in FIG. 5, the disclosed brake control system 110 may generally relate to a hydraulic braking arrangement for selectively actuating the vehicle's brake assemblies 72, 74. Specifically, as will be described in greater detail below, when the vehicle 10 is operated in a manual mode, actuation of the brake assemblies 72, 74 may be achieved by the operator pressing or engaging the associated brake pedals 30, 32 (or any other suitable manual brake input device). In contrast, when the vehicle 10 is operated in an autonomous and/or semi-autonomous mode, actuation of the brake assemblies 72, 74 may be achieved automatically by the computing system 120 controlling the operation of one or more control valves configured to regulate the supply of hydraulic fluid to the SAHR braking cylinder 86 of each brake assembly 72, 74.

As illustrated in FIG. 5, the brake control system 110 can include a vehicle brake module 160 configured to control the brake assemblies 72, 74 when the vehicle 10 is operated in the manual mode. Specifically, the vehicle brake module 160 may include the vehicle's brake pedals (e.g., the left and right brake pedals 30, 32) along with associated master brake cylinders 162, 164. Specifically, a first or left master brake cylinder 162 is coupled to the left brake pedal 30 such that actuation of the left brake pedal 30 results in hydraulic fluid being supplied to the primary braking cylinder 76 of the left brake assembly 72 (e.g., via a left service brake line 80a) in a manner that causes actuation of the primary braking piston 82 (FIG. 3) to engage the brake assembly 72. Similarly, a second or right master brake cylinder 164 is coupled to the right brake pedal 32 such that actuation of the right brake pedal 32 results in hydraulic fluid being supplied to the primary braking cylinder 76 of the right brake assembly 74 (e.g., via a right service brake line 80b) in a manner that causes actuation of the primary braking piston 82 (FIG. 3) to engage the brake assembly 74. In this regard, each primary braking cylinder 76 may function as a slave cylinders for its respective master brake cylinder 162, 164 when operating in the manual mode. As described above, each primary braking cylinder 76 includes a spring 84 (FIG. 3) that biases the associated piston 82 (FIG. 3) into its disengaged state such that the brake assembly 72, 74 is released when the operator releases the corresponding brake pedal 30, 32. It should be appreciated that, as an alternative to the brake pedals 30, 32, the vehicle brake module 160 may include any other suitable manual brake input device, such as any suitable buttons, knobs, levers, etc. housed within the vehicle's cab 28.

Moreover, as shown in FIG. 5, the brake control system 110 can include a control valve assembly 170 configured to be automatically controlled via the computing system 120 to regulate the operation of the brake assemblies 72, 74 when the vehicle 10 is operated in an autonomous or semi-autonomous mode. Specifically, the control valve assembly 170 may be configured to regulate the supply of hydraulic fluid to the SAHR braking cylinder 86 of each brake assembly 72, 74, thereby allowing the computing system 120 to control the engagement/disengagement of each brake assembly 72, 74 via control of the actuation of associated SAHR braking cylinder 86. As shown in FIG. 5, the control valve assembly includes a control valve 172, a bypass valve 174, and a double-poppet, zero-leakage or on-off valve 176. In addition, the control valve assembly 170 may also incorporate a pressure sensor 178 that is communicatively coupled to the computing system 120, thereby allowing the computing system 120 to monitor the pressure of the hydraulic fluid being directed through the valve assembly 170 to each of the SAHR braking cylinders 86.

In several embodiments, the control valve 172 of the valve assembly 170 may correspond to an electronically-activated, spring-biased two-position proportional valve configured to be actuated between a return position (as shown in FIG. 5) and a supply position. In one embodiment, the control valve 172 may be configured to be normally in (or spring-biased towards) the return position at which return fluid from the SAHR braking cylinder 86 can be directed through a corresponding tank line 180 to a fluid tank 182. In such an embodiment, the computing system 120 may be configured to actuate the valve 172 to the supply position (e.g., via control of an associated solenoid 184) against the bias of the spring. As shown in FIG. 5, at such position, pressurized hydraulic fluid from a pressurized fluid source (e.g., a pump 186) may be directed from a supply line 188 through the control valve 172 for delivery (ultimately) to the SAHR braking cylinder 86.

As indicated above, the control valve 172 may, in several embodiments, correspond to a proportional control valve, thereby allowing the control valve 172 to vary the pressure of the hydraulic fluid being supplied to the SAHR braking cylinder 86 to adjust a magnitude of the braking action or braking force being applied by the brake assemblies 72, 74. For instance, the position of the control valve 172 may be configured to be varied to allow the control valve 172 to supply pressurized hydraulic fluid to the SAHR braking cylinder 86 at or above a “disengagement” threshold pressure at which the SAHR piston 88 (FIG. 3) is actuated against the bias of the associated spring 94 (FIG. 3) to such an extent as to completely disengage or release the brake assemblies 72, 74. In addition, the position of the control valve 172 may be configured to be varied to allow pressurized hydraulic fluid to be supplied to the SAHR braking cylinder 86 at a pressure ranging from above a zero or nominal pressure to below the “disengagement” threshold pressure to adjust the amount of braking force or braking action being applied by the brake assemblies 72, 74. For instance, by decreasing the pressure from the “disengagement” threshold pressure towards zero or nominal pressure, the braking force or action applied by the brake assemblies 72, 74 will increase given the “spring-applied” configuration of the SAHR braking cylinder 86. Similarly, by increasing the pressure from the zero or nominal pressure towards the “disengagement” threshold pressure, the braking force or action applied by the brake assemblies 72, 74 will decrease given the “hydraulic-release” configuration of the SAHR braking cylinder 86. In this regard, the actuation of the SAHR braking cylinder 86 may be controlled in a manner that allows the brake assemblies 72, 74 to have the same or similar (including greater) braking sensitivity as can be achieved in the manual mode by the operator pressing the brake pedals 30, 32.

Referring still to FIG. 5, the bypass valve 174 of the control valve assembly 170 may generally be configured to provide a means for bypassing the control valve 171 to allow return fluid to be directed to tank 182 (and, thus, allowing the brake assemblies 72, 74 to be engaged) in the event of A malfunction or other operational error associated with the control valve 172. As shown in FIG. 5, the bypass valve 174 may correspond to an electronically-activated, spring-biased two-position valve configured to be actuated between a bypass position (as shown in FIG. 5) and a supply/return position. In one embodiment, the bypass valve 174 may be configured to be normally in (or spring-biased towards) the bypass position at which return fluid from the SAHR braking cylinder 86 can be directed through a bypass line 190 (i.e., that bypasses the control valve 172) to the tank line 180 for delivery to the tank 182. In such an embodiment, the computing system 120 may be configured to actuate the valve 174 to the supply/return position (e.g., via control of an associated solenoid 191) against the bias of the spring. During normal operation within the autonomous or semi-autonomous mode, the bypass valve 174 may be configured to be actuated to its supply/return position, thereby allowing pressurized hydraulic fluid supplied from the control valve 172 (e.g., when the control valve 172 is at its supply position) to be directed downstream to the SAHR braking cylinder 86 and also allowing return fluid from the SAHR braking cylinder 86 to be directed through the control valve 172 (e.g., when the control valve 172 is at its return position) for delivery to the tank line 180. However, in the event of a malfunction or other event in which the control valve 172 is unable to be actuated to its return position, the bypass valve 174 can be deactivated, thereby allowing the valve 174 to be spring-biased back to its bypass position to allow return fluid from the SAHR braking cylinder 86 to flow to the tank link 180 via the bypass line 190.

The on-off valve 176 of the control valve assembly 170 may generally be configured to be actuated between opened/closed states. As shown in FIG. 5, the on-off valve 176 may correspond to an electronically-activated, spring-biased two-position valve configured to be actuated between a closed position (as shown in FIG. 5) and an opened position. In one embodiment, the on-off valve 176 may be configured to be normally in (or spring-biased towards) the closed position to block the flow of hydraulic fluid therethrough. In such an embodiment, the computing system 120 may be configured to actuate the valve 176 to the opened position (e.g., via control of an associated solenoid 192) against the bias of the spring to allow the flow of hydraulic fluid therethrough. For instance, when the work vehicle 10 is operated in the autonomous or semi-autonomous mode, the computing system 120 may be configured to actuate the on-off valve 176 to its opened position to allow hydraulic fluid to freely flow through the valve 176. Additionally, as shown in FIG. 5, the on-off valve 176 may also include a manual override 193 to allow the valve 176 to be manually actuated between its opened and closed positions. For instance, an override input device 194 (e.g., a button or lever) may be located within the cab 28 of the work vehicle 10 (or at any other suitable location) to allow the operator to manipulate the valve's manual override 193 to actuate the valve 176 between the opened and closed positions, if necessary or desired. In one embodiment, the override input device 194 may be configured as a lever (e.g., a pull lever) that allows the operator to proportionally apply/release the brake assemblies 172, 174 (e.g., when applying/releasing the parking brake function). In such an embodiment, a proportional switch or valve or other proportional device may be associated with the override input device 194 to provide such functionality. In addition, a proximity switch or other sensor may be provided in operative association with the override input device 194 to allow the computing system 120 to automatically detect actuation or movement of the device 194.

Accordingly, upon receipt of an input indicating that the work vehicle 10 is to be operated within its autonomous or semi-autonomous mode, the computing system 120 may be configured automatically actuate the bypass valve 174 to its return/supply position (e.g., via control of the solenoid 191) and the on-off valve 176 to its opened position (via control of the solenoid 192). In addition, to release or disengage the brake assemblies 72, 74, the computing system 120 may be configured automatically actuate the control valve 172 to its supply position (e.g., via control of the solenoid 184) to allow pressurized hydraulic fluid to be supplied to the SAHR braking cylinder 86 at a pressure at or above the “disengagement” threshold pressure. Thereafter, to apply the brake assemblies 72, 74, the control valve 172 may be actuated towards its return position (e.g., via control of the solenoid 184) to reduce the pressure of the pressurized hydraulic fluid to be supplied to the SAHR braking cylinder 86 to a level below the “disengagement” threshold pressure. As indicated above, as a proportional control valve, the position of the control valve 172 may be varied to adjust the pressure the pressurized hydraulic fluid to be supplied to the SAHR braking cylinder 86 between a zero or nominal pressure and the “disengagement” threshold pressure, thereby allowing the control valve 172 to vary the magnitude or amount of braking actions/force applied by the brake assemblies 72, 74.

As shown in FIG. 5, the brake control system 110 may also include a secondary supply line 195 (e.g., a grease line) that allows fluid (e.g., grease) to be pumped or supplied to the SAHR braking cylinders 86 via secondary ports 86 to release or disengage the brake assemblies 72, 74. For instance, when the work vehicle 10 is being towed or operated in a tow mode, fluid may be supplied to the SAHR braking cylinders 86 via secondary ports 86 to release or disengage the brake assemblies 72, 74. In doing so, such fluid may be supplied from any suitable fluid source, such as a grease gun or any other suitable source.

It should be appreciated that the SAHR braking cylinder 86 of each brake assembly 72, 74 may allow for application of the parking or emergency brake in both the manual mode and the autonomous or semi-autonomous mode. For instance, a suitable brake input device may be provided within the cab 28 to allow the operator to control the operation of the control valve assembly 170 to engage the brake assemblies 72, 74 without the need to depress or actuate the brake pedals 30, 32. In such an embodiment, a proportional brake input device (e.g., a proportional switch) may be used to allow the operator to proportionally control the position of the control valve 172, thereby allowing the operator, in turn, to proportionally control the amount or magnitude of the braking action/force being applied.

It should also be appreciated that the manual override 193 provided in association with the on-off valve 176 prevents automatic application of the brakes (e.g., in the event of an electrical failure), preserving the ability for the operator to maintain manual braking via the brake pedals 30, 32. If the operator then opens the on-off valve 176 with the manual over-ride 193, the brakes will automatically apply. Similarly, if the operator is not present during operation within the autonomous mode and the manual override 193 is locked in the open position, then the brakes would automatically apply in the case of electric failure. Moreover, this manual override 193 may also be used to lock the on-off valve in the opened position, which may be desirable when the work vehicle 10 is intended to be operated in the autonomous mode while the operator is outside the cab 28.

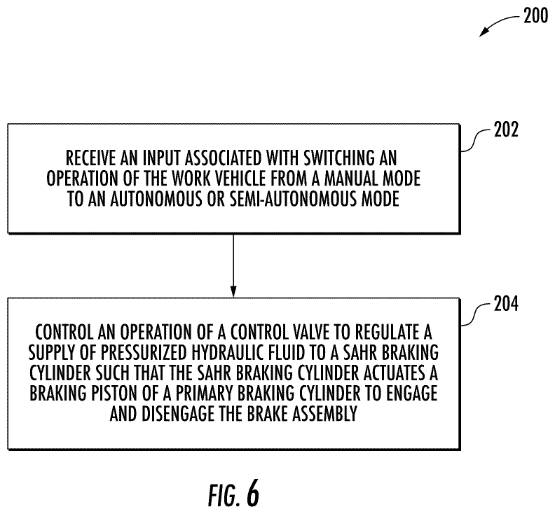

Referring now to FIG. 6, a flow diagram of one embodiment of a method 200 for braking a work vehicle is illustrated in accordance with aspects of the present subject matter. In general, the method 200 will be described herein with reference to the work vehicle 10 described above with reference to FIGS. 1 and 2, the brake assemblies 72, 74 described above with reference to FIG. 3, the control system 100 described above with reference to FIG. 4, and the brake control system 110 described above with reference to FIG. 5. However, it should be appreciated by those of ordinary skill in the art that the disclosed method 200 may generally be executed with any suitable work vehicle, with any suitable brake assemblies, any suitable control system and/or any suitable brake control system. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (202), the method 200 may include receiving an input associated with switching an operation of the work vehicle from a manual mode to an autonomous or semi-autonomous mode. As indicated above, the computing system 120 may be communicatively coupled to the user interface 36, thereby allowing the operator to provide inputs to the computing system 120. In this regard, when it is desired to transition operation of the work vehicle 10 from the manual mode to an autonomous or semi-autonomous mode, the operator may provide a suitable input (e.g., via the interface 36) instructing the computing system 120 to switch to the selected operating mode.

Additionally, at (204), the method 200 may include controlling an operation of a control valve to regulate a supply of pressurized hydraulic fluid to a SAHR braking cylinder such that the SAHR braking cylinder actuates a braking piston of a primary braking cylinder to engage and disengage the brake assembly. Specifically, as indicated above, when operating an autonomous or semi-autonomous mode, the computing system 120 may be configured to automatically control the operation of the control valve 172 to regulate the actuation of the SAHR braking cylinder 86, which, in turn, actuates the braking piston 82 of the primary braking cylinder 76 to engage or disengage the associated brake assembly 72, 74.

It is to be understood that the steps of the method 200 are performed by the computing system 120 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 120 described herein, such as the method 200, is implemented in software code or instructions which are tangibly stored on a tangible computer readable medium. The computing system 120 loads the software code or instructions via a direct interface with the computer readable medium or via a wired and/or wireless network. Upon loading and executing such software code or instructions by the computing system 120, the computing system 120 may perform any of the functionality of the computing system 120 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for braking a work vehicle, the system comprising:
a brake assembly comprising a primary braking cylinder and a spring-applied, hydraulic-release (SAHR) braking cylinder operatively coupled to the primary braking cylinder, the primary braking cylinder including a braking piston configured to actuate a brake element to engage and disengage the brake assembly;
a manual brake input device configured to actuate the braking piston when the work vehicle is operated in a manual mode;
a control valve configured to regulate a supply of pressurized hydraulic fluid to the SAHR braking cylinder; and
a computing system configured to control an operation of the control valve to regulate the supply of pressurized hydraulic fluid to the SAHR braking cylinder such that the SAHR braking cylinder actuates the braking piston when the work vehicle is operated in an autonomous mode or a semi-autonomous mode.

2. The system of claim 1, wherein the SAHR braking cylinder is configured to actuate the braking piston such that the brake assembly is fully engaged when the supply of pressurized hydraulic fluid to the SAHR braking cylinder is cut-off.

3. The system of claim 2, wherein the computing system is configured to control the operation of the control valve to supply the pressurized hydraulic fluid to the SAHR braking cylinder at or above a disengagement pressure to disengage the brake assembly.

4. The system of claim 3, wherein the control valve comprises a proportional control valve, the computing system being configured to control the operation of the proportional control valve to vary a pressure of the pressurized hydraulic fluid supplied to the SAHR braking cylinders at a level below the disengagement pressure to adjust a magnitude of a braking force applied by the brake assembly.

5. The system of claim 1, further comprising a bypass valve configured to allow return fluid from the SAHR braking cylinder to bypass the control valve.

6. The system of claim 1, further comprising an on-off valve positioned downstream of the control valve, the on-off valve actuatable between an open position, at which the pressurized hydraulic fluid from the control valve is allowed to flow through the on-off valve to the SAHR braking cylinder, and a closed position, at which the pressurized hydraulic fluid is not allow to flow through the on-off valve.

7. The system of claim 6, wherein the computing system is configured to control an operation of the on-off valve to actuate the on-off-valve between the open and closed positions, wherein the control of the on-off valve by the computing system is configured to be manually overridden to actuate the on-off-valve between the opened and closed positions.

8. The system of claim 1, wherein the SAHR braking cylinder is operatively coupled to the braking piston of the primary braking cylinder via a linkage such that actuation of the SAHR braking cylinder results in actuation of the braking piston.

9. The system of claim 1, wherein the manual brake input device comprises a brake pedal of the work vehicle.

10. A work vehicle, comprising:
first and second brake assemblies, each of the first and second brake assemblies comprising a primary braking cylinder and a spring-applied, hydraulic-release (SAHR) braking cylinder operatively coupled to the primary braking cylinder, the primary braking cylinder including a braking piston configured to actuate a brake element to engage and disengage the respective first or second brake assembly;
first and second manual brake input devices configured to actuate the braking piston of the first and second brake assemblies, respectively, when the work vehicle is operated in a manual mode;
a control valve configured to regulate a supply of pressurized hydraulic fluid to the SAHR braking cylinder of each of the first and second brake assemblies; and
a computing system configured to control an operation of the control valve to regulate the supply of pressurized hydraulic fluid to the SAHR braking cylinders of the first and second brake assemblies such that the SAHR braking cylinders actuate the braking pistons of the primary braking cylinders of the first and second brake assemblies when the work vehicle is operated in an autonomous mode or a semi-autonomous mode.

11. The work vehicle of claim 10, wherein each SAHR braking cylinder is configured to actuate the braking piston of the respective primary braking cylinder such that each of the first and second brake assemblies is fully engaged when the supply of pressurized hydraulic fluid to each SAHR braking cylinder is cut-off.

12. The work vehicle of claim 11, wherein the computing system is configured to control the operation of the control valve to supply the pressurized hydraulic fluid to the SAHR braking cylinders at or above a disengagement pressure to disengage the first and second brake assemblies.

13. The work vehicle of claim 12, wherein the control valve comprises a proportional control valve, the computing system being configured to control the operation of the proportional control valve to vary a pressure of the pressurized hydraulic fluid supplied to the SAHR braking cylinders at a level below the disengagement pressure to adjust a magnitude of a braking force applied by the first and second brake assemblies.

14. The work vehicle of claim 10, wherein each SAHR braking cylinder is operatively coupled to the braking piston of the respective primary braking cylinder via a linkage such that actuation of the SAHR braking cylinder results in actuation of the braking piston.

15. The work vehicle of claim 10, wherein the first and second manual brake input devices comprise first and second brake pedals of the work vehicle.

16. A method for braking a work vehicle, the work vehicle including a brake assembly including a primary braking cylinder and a spring-applied, hydraulic-release (SAHR) braking cylinder operatively coupled to the primary braking cylinder, the primary braking cylinder including a braking piston configured to actuate a brake element to engage and disengage the brake assembly, the method comprising:
receiving, with a computing system, an input associated with switching an operation of the work vehicle from a manual mode to an autonomous or semi-autonomous mode;
controlling, with the computing system, an operation of a control valve to regulate a supply of pressurized hydraulic fluid to the SAHR braking cylinder such that the SAHR braking cylinder actuates the braking piston to engage and disengage the brake assembly.

17. The method of claim 16, wherein controlling the operation of the control valve comprises controlling the operation of the control valve to cut-off the supply of pressurized hydraulic fluid to the SAHR braking cylinder to fully engage the brake assembly.

18. The method of claim 17, wherein controlling the operation of the control valve further comprises controlling the operation of the control valve to supply the pressurized hydraulic fluid to the SAHR braking cylinder at or above a disengagement pressure to disengage the brake assembly.

19. The method of claim 18, wherein controlling the operation of the control valve further comprises proportionally controlling the operation of the control valve to regulate a pressure of the pressurized hydraulic fluid supplied to the SAHR braking cylinder to a level below the disengagement pressure to adjust a magnitude of a braking force applied by the brake assembly.

20. The method of claim 12, wherein the work vehicle further comprises an on-off valve positioned downstream of the control valve, the on-off valve actuatable between an open position, at which the pressurized hydraulic fluid from the control valve is allowed to flow through the on-off valve to the SAHR braking cylinder, and a closed position, at which the pressurized hydraulic fluid is not allowed to flow through the on-off valve, further comprising controlling an operation of the on-off valve to shift the on-off-valve from the closed position to the open position following receipt of the input.
